(19) United States
(12) Patent Application Publication
(10) Pub. No.: US 2018/0341580 A1
(43) Pub. Date: Nov. 29, 2018

(54) METHODS FOR ACCESSING SSD (SOLID STATE DISK) AND APPARATUSES USING THE SAME

(71) Applicant: Shannon Systems Ltd., Shanghai (CN)

(72) Inventor: Ningzhong MIAO, Shanghai (CN)

(21) Appl. No.: 15/865,480

(22) Filed: Jan. 9, 2018

(30) Foreign Application Priority Data
May 26, 2017 (CN) 201710383719.1

(51) Int. Cl. G06F 12/02; G06F 11/10; G06F 9/4401; G06F 9/48; G06F 3/06

(52) U.S. Cl. CPC G06F 12/0246; G06F 12/0292; G06F 12/0253; G06F 11/1048; G06F 11/108; G06F 9/4411; G06F 2009/45579; G06F 3/064; G06F 3/0659; G06F 3/061; G06F 3/0679; G06F 2212/2022; G06F 9/4881

(57) ABSTRACT

A method for accessing an SSD (Solid State Disk), performed by a processing unit when loading and executing a driver, including: selecting either a first queue or a second queue, wherein the first queue stores a plurality of regular access commands issued by an application and the second queue stores a plurality of access optimization commands; removing the data access command that arrived earliest from the selected queue; and generating a data access request comprising a physical location according to the removed data access command and sending the data access request to the SSD.

### CROSS REFERENCE TO RELATED APPLICATIONS

This Application claims priority of China Patent Application No. 201710383719.1, filed on May 26, 2017, the entirety of which is incorporated by reference herein.

### BACKGROUND

### Technical Field

The present invention relates to storage devices, and in particular to methods for accessing an SSD (Solid State Disk) and apparatuses using the same.

### Description of the Related Art

An SSD is typically equipped with NAND flash devices. NAND flash devices are not random access but serial access. It is not possible for NOR to access any random address. Instead, the host has to write into the NAND flash devices a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. Typically, the processing unit of an SSD needs to perform certain storage optimization procedures, such as a garbage collection procedure or an error recovery procedure, so as to use the storage space of the SSD effectively. However, since the moment at which the host will request to access data cannot be predicted, the storage optimization procedures may be interrupted and fail to complete their tasks when the host does request data. Accordingly, what is needed are methods for accessing an SSD to address the aforementioned problems, and apparatuses that use these methods.

### BRIEF SUMMARY

An embodiment of a method for accessing an SSD (Solid State Disk), performed by a processing unit when loading and executing a driver, comprises: selecting either a first queue or a second queue; removing the data access command that arrived earliest from the selected queue; and generating a data access request comprising a physical location according to the removed data access command and sending the data access request to the SSD.

An embodiment of an apparatus for accessing an SSD, comprises: a memory; and a processing unit coupled to the memory. The memory comprises a first queue and a second queue. The processing unit, when loading and executing a driver, selects either the first queue or the second queue; removes the data access command that arrived earliest from the selected queue; and generates a data access request comprising a physical location according to the removed data access command and sends the data access request to the SSD.

The first queue stores a plurality of regular access commands issued by an application and the second queue stores a plurality of access optimization commands.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is the system architecture of a computer apparatus according to an embodiment of the invention:

FIG. 2 is the system architecture of an SSD according to an embodiment of the invention:

FIG. 3 is a schematic diagram illustrating an access interface to a storage unit according to an embodiment of the invention;

FIG. 4 is a schematic diagram depicting connections between one access sub-interface and multiple storage sub-units according to an embodiment of the invention;

FIG. 5 is a schematic diagram illustrating layers of PCI-E (Peripheral Component Interconnect Express) according to an embodiment of the invention;

FIG. 6 is a block diagram of a device for accessing an SSD according to an embodiment of the invention:

FIG. 7 is a flowchart illustrating a method for accessing an SSD according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises.” “comprising.” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”. “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

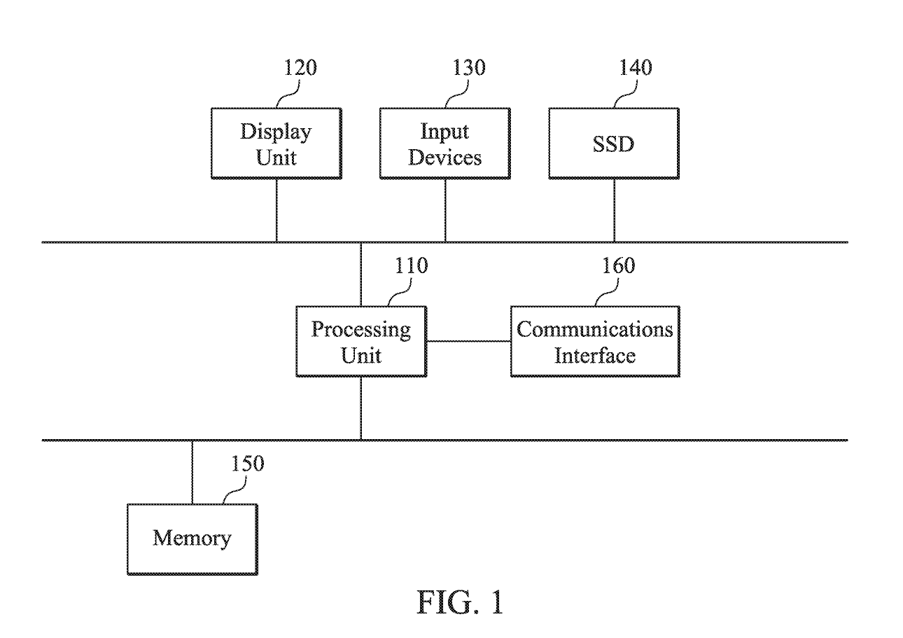

FIG. 1 is the system architecture of a computer apparatus according to an embodiment of the invention. The system architecture may be practiced in a desktop computer, a notebook computer, a tablet computer, a mobile phone, or another electronic apparatus with a computation capability. A processing unit 110 can be implemented in numerous ways, such as with dedicated hardware, or with general-purpose hardware (e.g., a single processor, multiple processors or graphics processing units capable of parallel computations, etc.) that is programmed using microcode or software instructions to perform the functions recited herein. The processing unit 110 may include an ALU (Arithmetic and Logic Unit) and a bit shifter. The ALU is responsible for performing Boolean operations (such as AND, OR, NOT, NAND, NOR. XOR, XNOR etc.) and also for performing integer or floating-point addition, subtraction, multiplication, division, etc. The bit shifter is responsible for bitwise shifts and rotations. The system architecture further includes a memory 150 for storing necessary data in execution, such as variables, data tables, etc., and an SSD (Solid State Disk) 140 for storing a wide range of electronic files, such as Web pages, digital documents, video files, audio files, etc. A communications interface 160 is included in the system architecture and the processing unit 110 can thereby communicate with another electronic apparatus. The communications interface 160 may be a LAN (Local Area Network) communications module or a WLAN (Wireless Local Area Network) communications module. The system architecture further includes one or more input devices 130 to receive user input, such as a keyboard, a mouse, a touch panel, etc. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. A display unit 120 may include a display panel, such as a TFT-LCD (Thin film transistor liquid-crystal display) panel or an OLED (Organic Light-Emitting Diode) panel, to display input letters, alphanumeric characters, symbols, dragged paths, drawings, or screens provided by an application for the user to view. The processing unit 110 is disposed physically outside of the SSD 140.

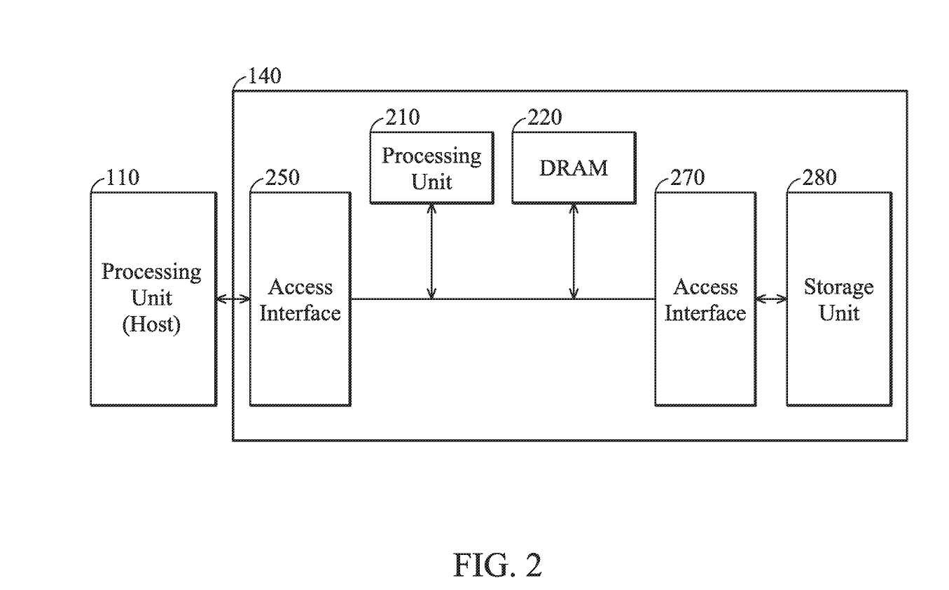

FIG. 2 is the system architecture of an SSD according to an embodiment of the invention. The system architecture of the SSD 140 contains a processing unit 210 being configured to write data into a designated address of a storage unit 280, and read data from a designated address thereof. Specifically, the processing unit 210 writes data into a designated address of the storage unit 280 through an access interface 270 and reads data from a designated address thereof through the same interface 270. The system architecture uses several electrical signals for coordinating commands and data transfer between the processing unit 210 and the storage unit 280, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc. The access interface 270 may communicate with the storage unit 280 using a SDR (Single Data Rate) protocol or a DDR (Double Data Rate) protocol, such as ONFI (open NAND flash interface), DDR toggle, or others. The processing unit 210 may communicate with the processing unit 110 (may be referred to as a host) through an access interface 250 using a standard protocol, such as USB (Universal Serial Bus), ATA (Advanced Technology Attachment), SATA (Serial ATA), PCI-E (Peripheral Component Interconnect Express) or others.

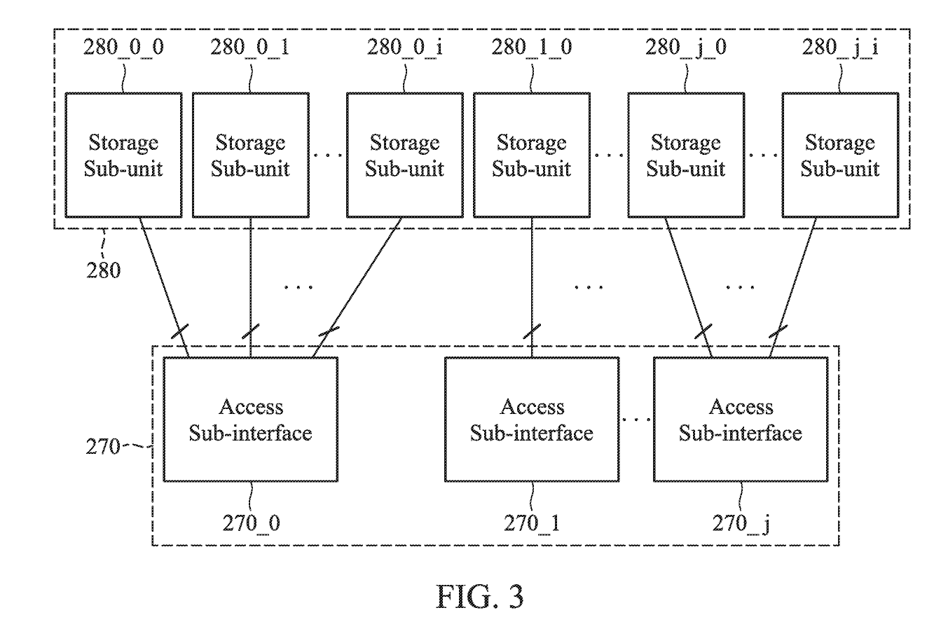

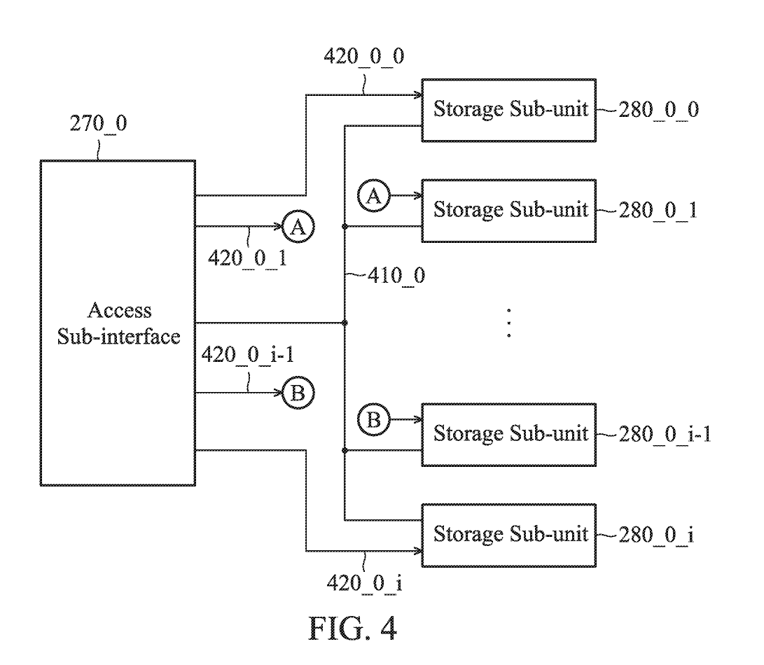

The storage unit 280 may contain multiple storage sub-units and each storage sub-unit may be practiced in a single die and use a respective access sub-interface to communicate with the processing unit 210. FIG. 3 is a schematic diagram illustrating an access interface to a storage unit according to an embodiment of the invention. The SSD 140 may contain j+1 access sub-interfaces 270_0 to 270_j, where the access sub-interfaces may be referred to as channels, and each access sub-interface connects to i+1 storage sub-units. That is, i+1 storage sub-units may share the same access sub-interface. For example, assume that the SSD 140 contains 4 channels (j=3) and each channel connects to 4 storage sub-units (i=3): The SSD 140 has 16 storage sub-units 280_0_0 to 280j_i in total. The processing unit 210 may direct one of the access sub-interfaces 270_0 to 270j to read data from the designated storage sub-unit. Each storage sub-unit has an independent CE control signal. That is, it is required to enable a corresponding CE control signal when attempting to perform a data read from a designated storage sub-unit via an associated access sub-interface. It is apparent that any number of channels may be provided in the SSD 140, and each channel may be associated with any number of storage sub-units, and the invention should not be limited thereto. FIG. 4 is a schematic diagram depicting connections between one access sub-interface and multiple storage sub-units according to an embodiment of the invention. The processing unit 210, through the access sub-interface 270_0, may use independent CE control signals 420_0_0 to 420_0_i to select one of the connected storage sub-units 280_0_0 and 280_0_i, and then program data into the designated location of the selected storage sub-unit via the shared data line 410_0.

In some implementations, the processing unit 210 needs to perform certain storage optimization procedures, such as a garbage collection procedure, an error recovery procedure, etc., so as to use the storage space of the storage unit 280 more effectively. However, the optimization procedure being performed may be interrupted when a data access request is received from the host 110. To address the aforementioned problems, embodiments of the invention introduce methods for accessing an SSD and apparatuses that use these methods to enable the processing unit 110 (i.e. the host 110) to schedule a wide range of data access tasks.

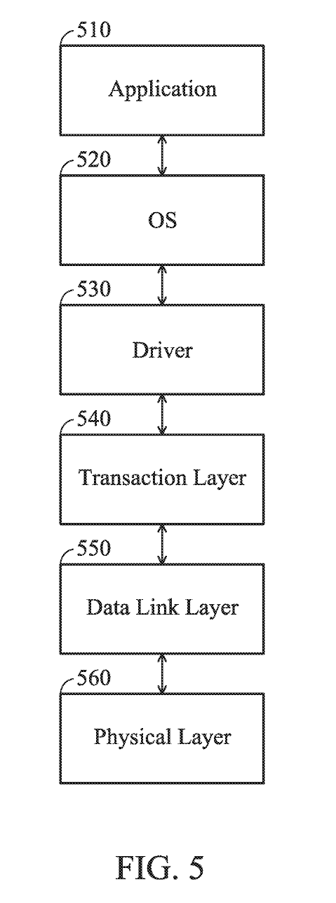

FIG. 5 is a schematic diagram illustrating layers of PCI-E (Peripheral Component Interconnect Express) according to an embodiment of the invention. An application 510 reads data from a designated address of the SSD 140 or writes data into a designated address of the SSD 140 through an OS (Operating System) 520. The OS 520 sends commands to a driver 530 and the driver 530 generates and sends a corresponding read or write request to a transaction layer 540 accordingly. The transaction layer 540 employs the split-transaction protocol in the packet architecture to the SSD 140 through a data link layer 550 and a physical layer 560.

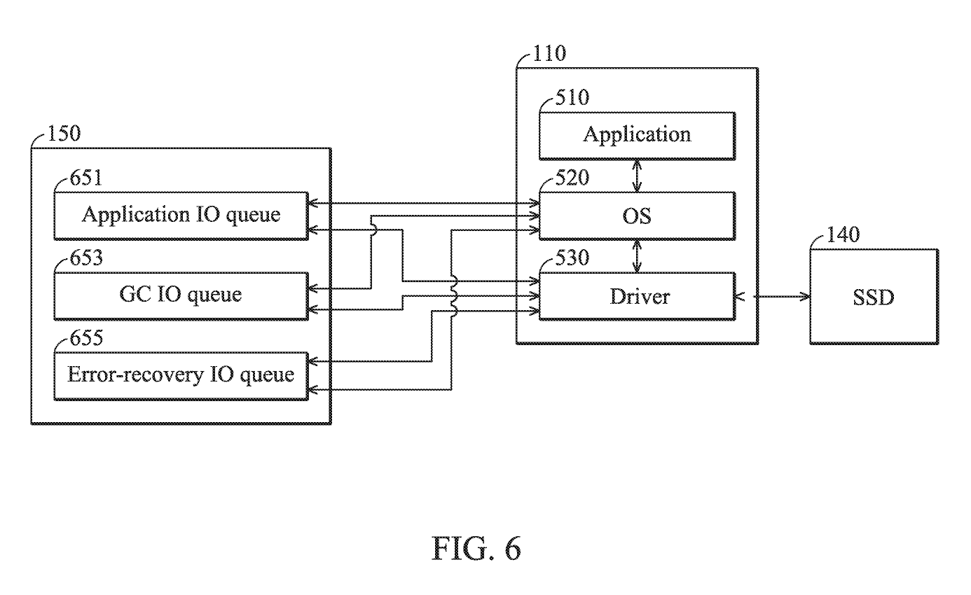

FIG. 6 is a block diagram of a device for accessing an SSD according to an embodiment of the invention. Space of the memory 150 may be allocated for IO (Input-Output) queues 651 to 655 and the IO queues 651 to 655 are FIFO (First-In-First-Out) queues. Specifically, the data access command that is the latest obtained from the application 510 is pushed to the bottom of the corresponding queue (also referred to as an enqueue) and the data access command that is entered earliest is popped out from the top of the queue and processed (also referred to as a dequeue). The OS 520 and/or the driver 530 executed by the processing unit 110 may push each of the data access commands into one of the IO queues 651 to 655 according to a type of the data access command. The data access commands issued by the application 510 may be pushed into the application 10 queue 651 according to the moments at which the data access commands arrive. The data access commands stored in the application 10 queue 651 may be referred to as regular access commands. In some embodiments, each regular access command may include an original logical location provided by the application 510. In some embodiments, the OS 520 or the driver 530 may convert the original logical location provided by the application 510 into a physical location that can be recognized by the storage unit 280. If the data in some of the pages of the blocks of the storage unit 280 are no longer needed (these are also called stale pages), only the pages with good data in those blocks are read and collected from blocks and the collected pages of good data are reprogrammed into another previously erased empty block. Then the free blocks are available for new data after being erased. This is a procedure called GC (garbage collection). The procedure of GC involves reading data from the SSD 140 and reprogramming data into the SSD 140. The OS 520 may push the data access commands of the GC procedure into the GC 10 queue 653. The data access commands of the GC IO queue 653 may be referred to as GC access commands and each GC access command include information regarding a logical location and a physical location. To ensure the accuracy of the stored messages, the OS 520 or the driver 530 may append one-dimensional or two-dimensional ECC (error correction code) to protect the original data provided by the application 510. The ECC may be implemented in SPC (single parity correction) code, RS (Reed-Solomon) code, or others. After numerous data reads and writes, raw data of the storage unit 280 may contain errors. When an error rate for raw data stored in one or more segments exceeds a threshold, the OS 520 or the driver 530 may arrange a period of time to read the raw data and ECC from the storage unit 280, corrects errors in the raw data and the ECC, and reprogram the corrected raw data and the corrected ECC into the original block(s) or empty block(s) of the storage unit 280. This is a procedure called error recovery. The procedure of error recovery also involves reading data from the SSD 140 and reprogramming data into the SSD 140. The OS 520 may push the data access commands of the error recovery procedure into the error-recovery IO queue 655. The data access commands of the error-recovery IO queue 655 may be referred to as error-recovery access commands and each error-recovery access command include information regarding a logical location and a physical location. The GC and error-recovery access commands may be referred to as access optimization commands collectively and the GC IO queue 653 and the error recovery IO queue 655 may be integrated into a single access optimization queue.

The OS 520 or the driver 530 may define QoS (Quality of Service) for different types of data access commands, such as regular, GC and error-recovery access commands, and so on, thereby enabling the data access commands of different types to be scheduled according to the QoS and an execution log. The driver 530 may record the execution log for different types of data access commands in execution. The execution log contains records and each record may store information regarding an access type, a request type, an execution time, a logical location, a physical location, etc. For example, a record stores information indicating that data of a logical location was read from a specific physical location of the SSD 140 for a GC procedure at a first moment. Another record stores information indicating that the data of the logical location was programmed into a new physical location of the SSD 140 for the GC procedure at a second moment. The QoS and the execution log of different types may be realized in a particular data structure, such as a data array, a database table, a file record, etc., and may be stored in the memory 150.

In order to optimize the efficiencies of data read and data write, the driver 530 may distribute data with continuous LBAs (Logical Block Addresses) across different physical regions of the storage unit 280. The memory 150 may store a storage mapping table, also referred to as an H2F (Host-to-Flash) table, to indicate which physical location of the storage unit 280 the data of each LBA is physically stored in. The logical locations may be represented by LBAs, and each LBA is associated with a fixed-length of physical storage space, such as 256K, 512K or 1024K bytes. For example, an H2F table stores physical locations associated with the logical storage addresses from LBA0 to LBA65535 in sequence. The physical location associated with each logical block may be represented in four bytes, two bytes are used to record a block number and two bytes are used to record a unit number. After a regular, GC or error-recovery access command is executed, the H2F table is updated if necessary. It should be noted that the optimization of physical-data placement cannot be realized by the conventional host because it does not have the knowledge of a H2F table, or the like.

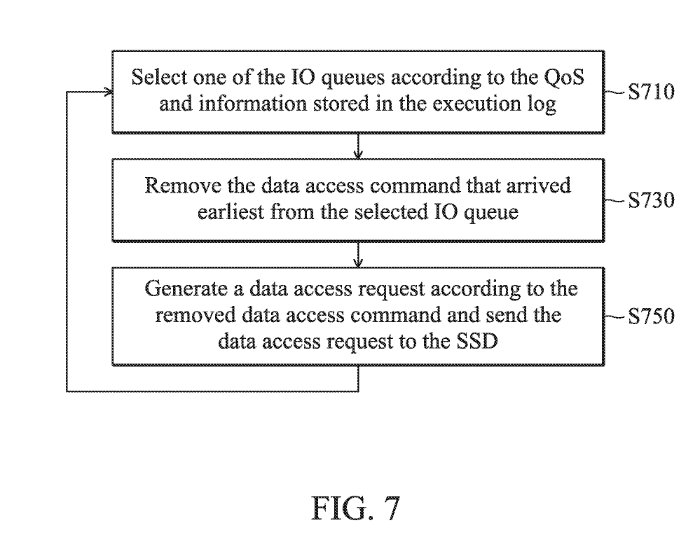

Better than the aforementioned implementations, the method for accessing an SSD introduced in embodiments of the invention can avoid executions of regular access commands to be interfered with a storage optimization procedure. FIG. 7 is a flowchart illustrating a method for accessing an SSD according to an embodiment of the invention. The method is performed when the processing unit 110 loads and executes the driver 530. The method repeatedly executes a loop (steps S710 to S750) for dealing with a data access command issued from the application 510. In each iteration, one of the IO queues 651 to 655 is selected according to the QoS and information stored in the execution log (step S710), the data access command that arrived earliest is removed from the selected 10 queue, where the removed data access command contains information regarding at least a command type, a logical location and, optionally, a physical location (step S730), and a data access request is generated according to the removed data access command and the data access request is sent to the SSD 140, where the data access request contains information regarding at least a request type and a physical location (step S750). The command type of each data access command may be a data read, a data write, or others. In step S710, for example, the driver 530 obtains data access commands of different types by using a round-robin algorithm, thereby enabling the executions of the data access commands of different types to reach predefined percentages for different types of the data access commands. For example, the executed data access commands substantially contain 70% being regular access commands, 20% being GC access commands and 10% being error-recovery access commands. Or, the priority for the regular access commands is set to the highest than the other two and the waiting time for each GC access command or each error-recovery access command is limited to a threshold. Accordingly, the driver 530 executes the regular access commands when the waiting times for all of the GC and error-recovery access commands do not exceed the threshold and executes the GC or error-recovery access commands when their waiting times will reach the threshold in a short time. In step S750, when the removed data access command does not contain information regarding a physical location, the driver 530 reads a physical location associated with the logical address of the data access command from the H2F table. After receiving a data access request, the processing unit 210 of the SSD 140 performs no conversion for translating a logical location into a physical location and vice versa. The processing unit 210 of the SSD 140 obtains a physical location from the data access request and drives the access interface 270 to read data from the physical location of the storage unit 280 or program data into the physical location of the storage unit 280.

Although the embodiment has been described as having specific elements in FIGS. 1-4 and 6, it should be noted that additional elements may be included to achieve better performance without departing from the spirit of the invention. While the process flow described in FIG. 7 includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for accessing an SSD (Solid State Disk), performed by a processing unit when loading and executing a driver, comprising:
selecting either a first queue or a second queue, wherein the first queue stores a plurality of regular access commands issued by an application and the second queue stores a plurality of access optimization commands;
removing a data access command that arrives earliest from the selected queue; and
generating a data access request comprising a physical location according to the removed data access command and sending the data access request to the SSD.

2. The method of claim 1, wherein the step of generating a data access request comprising a physical location according to the removed data access command and sending the data access request to the SSD comprises:
when the removed data access command comprises a logical location and does not contain information regarding the physical location, reading the physical location associated with the logical location from a storage mapping table.

3. The method of claim 2, wherein the storage mapping table stores information indicating which physical location of a storage unit of the SSD data of each logical location is physically stored in.

4. The method of claim 1, wherein the access optimization commands comprise a plurality of GC (garbage collection) access commands of a GC procedure.

5. The method of claim 4, wherein the GC procedure reads and collects pages of good data from a plurality of blocks of a storage unit of the SSD and reprograms the collected pages of good data into an empty block of the storage unit of the SSD.

6. The method of claim 1, wherein the access optimization commands comprise a plurality of error-recovery access commands of an error recovery procedure.

7. The method of claim 6, wherein the error recovery procedure reads raw data and ECC (error correction code) from a storage unit of the SSD, corrects errors in the raw data and the ECC and reprograms the corrected raw data and the corrected ECC into the storage unit of the SSD.

8. The method of claim 1, wherein the processing unit is disposed physically outside of the SSD.

9. The method of claim 1, wherein the step of selecting either a first queue or a second queue comprises:
selecting either the first queue or the second queue according to QoS (Quality of Service) and an execution log.

10. An apparatus for accessing an SSD (Solid State Disk), comprising:
a memory, comprising a first queue and a second queue, wherein the first queue stores a plurality of regular access commands issued by an application and the second queue stores a plurality of access optimization commands; and
a processing unit, coupled to the memory, when loading and executing a driver, selecting either the first queue or the second queue; removing a data access command that arrived earliest from the selected queue; and generating a data access request comprising a physical location according to the removed data access command and sending the data access request to the SSD.

11. The apparatus of claim 10, wherein the memory stores a storage mapping table and, when the removed data access command comprises a logical location and does not contain information regarding the physical location, the processing unit reads the physical location associated with the logical location from the storage mapping table.

12. The apparatus of claim 11, wherein the storage mapping table stores information indicating which physical location of a storage unit of the SSD data of each logical location is physically stored in.

13. The apparatus of claim 10, wherein the access optimization commands comprise a plurality of GC (garbage collection) access commands of a GC procedure.

14. The apparatus of claim 13, wherein the GC procedure reads and collects pages of good data from a plurality of blocks of a storage unit of the SSD and reprograms the collected pages of good data into an empty block of the storage unit of the SSD.

15. The apparatus of claim 10, wherein the access optimization commands comprise a plurality of error-recovery access commands of an error recovery procedure.

16. The apparatus of claim 15, wherein the error recovery procedure reads raw data and ECC (error correction code) from a storage unit of the SSD, corrects errors in the raw data and the ECC and reprograms the corrected raw data and the corrected ECC into the storage unit of the SSD.

17. The apparatus of claim 10, wherein the processing unit is disposed physically outside of the SSD.

18. The apparatus of claim 10, wherein the processing unit selects either the first queue or the second queue according to QoS (Quality of Service) and an execution log.
